(19) United States
(12) Patent Application Publication
(10) Pub. No.: US 2013/0275924 A1
(43) Pub. Date: Oct. 17, 2013

(54) LOW-ATTENTION GESTURAL USER INTERFACE

(71) Applicant: NUANCE COMMUNICATIONS, INC., Burlington, MA (US)

(72) Inventors: Garrett Laws Weinberg, Arlington, MA (US); Patrick Lars Langer, Neu-Ulm (DE); Timothy Lynch, North Reading, MA (US); Victor Shine Chen, Saratoga, CA (US); Lars König, Ulm (DE); Slawek Paul Jarosz, Senneville (CA); Andrew Knowles, Montreal (CA)

(73) Assignee: NUANCE COMMUNICATIONS, INC., Burlington, MA (US)

(21) Appl. No.: 13/833,780

(22) Filed: Mar. 15, 2013

Related U.S. Application Data
(60) Provisional application No. 61/625,070, filed on Apr. 16, 2012.

(51) Int. Cl. G06F 3/01

(52) U.S. Cl. CPC G06F 3/017
USPC 715/863

(57) ABSTRACT

A system and method to generate a touch-based user interface that allows users to reliably carry out tasks in a low-attention environment. The touch-based user interface relies upon swipe and tap gestures that are easily entered by a user without having to concentrate on a touchscreen or display associated with a touchpad on which the gestures are entered. For gestures that are swipes, only the direction of the swipe is utilized by the system in interpreting the entered command. For tap gestures, only the number of taps in a sequence, as well as the duration of taps, is utilized by the system in interpreting the entered command. By not correlating the location of the entered gestures with what is displayed on the associated display screen, the touch interface disclosed herein is well suited for environments where a user is unable to look at the display screen while performing gestures.

### CROSS-REFERENCE TO RELATED APPLICATION

This application claims the benefit of U.S. Provisional Patent Application No. 61/625,070, entitled “LOW-ATTENTION GESTURAL USER INTERFACE,” filed Apr. 16, 2012, which is incorporated herein by reference in its entirety.

### BACKGROUND

Conventional touch user interfaces fall into two categories: direct-touch, in which a display and a touch sensitive surface are integrated, and indirect-touch, in which a touch sensitive surface is separate from an associated display. An example of a direct-touch user interface is a capacitive touchscreen as found on many smartphones, such as the Apple iPhone. An example of an indirect-touch user interface is a touchpad used in conjunction with an LCD display, as found in many laptops. A user may experience difficulties when using either of these types of conventional interfaces in “low-attention” environments where the user can not or should not focus his attention on the user interface, such as when a user is simultaneously operating an automobile, airplane, boat, or heavy equipment. For example, when a user drives an automobile but focuses his eyes and attention on a touchscreen device, such as an integrated touchscreen console, navigation display, music player, or smart phone, a collision may be more likely to occur.

Some examples of conventional touch user interfaces may require the user to direct their visual attention to the display. As a first example, some input tasks may require the user to look at a display in order to target specific points or localized areas on a touchscreen or other touch-sensitive surface. To illustrate, to activate or otherwise utilize widgets, lists, virtual buttons, sliders, knobs, or other displayed items, a user may need to continually focus his visual attention on a display in order to target his touch to a specific point or area on a touchscreen or touchpad. As a second example, some user interfaces may accept broad “swipe” gestures where the velocity and/or distance of the broad swipe gesture indicates the user's intended action. To illustrate, a fast swipe gesture may cause a display to scroll or shift further than a slower swipe gesture and a long swipe gesture may cause a display to scroll or shift further than a shorter swipe gesture. Thus, in a low-attention environment, such as an automobile or airplane cockpit, a user may experience particularly acute difficulties using conventional broad swipe gestures for several reasons. First, after using a broad swipe gesture, a user will typically need to look at the screen to determine the degree to which the velocity and/or extent of the gesture affected the display. Second, a user may be unable to precisely control the velocity and extent of a swipe gesture, e.g., if he encounters hard acceleration, rough terrain, or turbulence. Third, some portion of the screen may be inactive or contain distinct target points or areas and therefore be unavailable for receiving swipe gestures, so the user may need to glance at the screen to either initiate a swipe or to confirm that a performed swipe had its intended effect.

The examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram showing typical hardware components of a touch-based system suitable for users in low-attention environments.

FIG. 2 is a perspective diagram of the touch-based system of FIG. 1 in an automotive application for use by a driver.

FIGS. 3A-C are screenshots of a representative user interface that illustrate exemplary functions that can be provided to a driver on a display screen, including: a vehicle navigation application; a music player; and a news reader.

FIG. 3D is a schematic of exemplary horizontal-swipe gestures that the driver can perform on a touch sensor in order to navigate from a current function to an adjacent function.

FIG. 4A is a screenshot of a representative user interface that illustrates exemplary vertically-navigable list items that can be provided on a display screen to a driver, such as additional functionality within a selected music player.

FIG. 4B is a screenshot of an exemplary user interface of a music player.

FIG. 4C is a schematic of exemplary single tap gestures that a user may perform on a touch sensor in order to cause the music player to begin playing a navigated music track.

FIGS. 5A-C are screenshots of an exemplary user interface of a navigation application, such as might be used in an automobile to find and navigate to a nearby point of interest in a “shopping” category.

FIG. 6 is a flow diagram of a method of detecting a gesture and mapping the gesture to a command associated with the displayed user interface.

### DETAILED DESCRIPTION

A system and method to generate a touch-based user interface that allows users to reliably carry out tasks in a low-attention environment is disclosed herein. The touch-based user interface relies upon swipe and tap gestures that are easily entered by a user without having to concentrate on a touchscreen or display associated with a touchpad on which the gestures are entered. For example, a user may perform swipe and tap gestures anywhere on the surface of a touchscreen or touchpad (hereinafter “touch sensor”). For gestures that are swipes, only the direction of the swipe is utilized by the system in interpreting the entered command. Accordingly, the location on the touch sensor where the swipe gesture originates (or is terminated) is not utilized by the system. Moreover, the extent of the swipe gesture (i.e., the overall magnitude or size of the swipe gesture) and velocity are not utilized by the system, provided the extent of the swipe gesture is sufficient for the user interface to distinguish the gesture as a swipe instead of a tap. For tap gestures, only the number of one or more taps in a sequence, as well as the duration of the one or more taps, are utilized by the system in interpreting the entered command. That is, the location of the entered tap is not utilized by the system. By not correlating the location of the entered gestures with what is displayed on the associated display screen, the touch interface disclosed herein is well suited for environments where the user is unable to look at the display screen while performing gestures. For example, the touch-based user interface allows drivers of a moving vehicle to access entertainment and other information with minimal distraction while driving.

Because the user does not need to target a specific location on the touch sensor, the disclosed user interface provides higher accuracy of properly recognizing user commands when the user is not able to look at the associated display screen. By eliminating the need to target a specific area of the touch sensor, the user is not required to divert his attention and vision toward the associated display screen while performing an input, and can more safely perform other simultaneous actions, such as driving a vehicle. By only briefly glancing at the display screen, such as to view information displayed on the screen after requesting the information, the user can focus a larger portion of his vision, and his attention, on other simultaneous tasks.

In some embodiments, auditory feedback confirms to the user that the system has processed a given command, in order to further reduce the need for the user to look at the display screen. For example, synthesized spoken prompts or connotative sound effects can serve to confirm to the user that the system has processed a given input without the user needing to look at the display.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

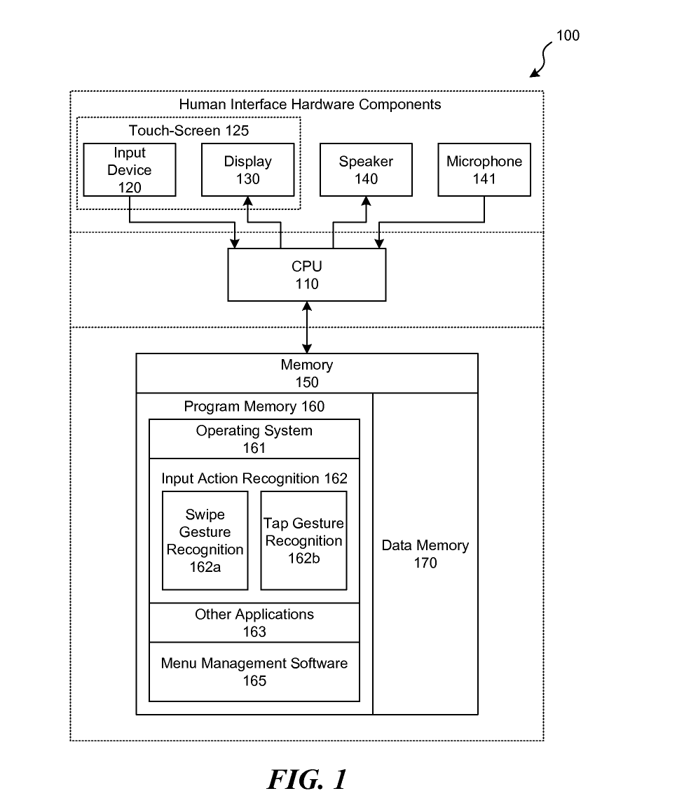

FIG. 1 is a simplified system block diagram of the hardware components of a typical system 100 for implementing a user interface that is optimized for use in a low-attention environment. The system 100 includes one or more input devices 120 that provide input to the CPU (processor) 110, notifying it of actions performed by a user, typically mediated by a hardware controller that interprets the raw signals received from the input device and communicates the information to the CPU 110 using a known communication protocol. The CPU may be a single or multiple processing units in a device or distributed across multiple devices. One example of an input device 120 is a touchscreen 125 that provides input to the CPU 110 notifying it of contact events when the touchscreen is touched by a user. Similarly, the CPU 110 communicates with a hardware controller for a display 130 on which text and graphics are displayed. One example of a display 130 is a display of the touchscreen 125 that provides graphical and textual visual feedback to a user. Optionally, a speaker 140 is also coupled to the processor so that any appropriate auditory signals can be passed on to the user as guidance, and a microphone 141 is also coupled to the processor so that any spoken input can be received from the user (predominantly for systems implementing speech recognition as a method of input by the user). In some embodiments, the speaker 140 and the microphone 141 are implemented by a combined audio input-output device.

The processor 110 has access to a memory 150, which may include a combination of temporary and/or permanent storage, and both read-only and writable memory (random access memory or RAM), read-only memory (ROM), writable non-volatile memory, such as flash memory, hard drives, floppy disks, and so forth. The memory 150 includes program memory 160 that contains all programs and software, such as an operating system 161, an input action recognition software 162, and any other application programs 163. The input action recognition software 162 includes input gesture recognition components, such as a swipe gesture recognition portion 162a and a tap gesture recognition portion 162b. The program memory 160 may also contain menu management software 165 for graphically displaying two or more choices to a user and determining a selection by a user of one of said graphically displayed choices according to the disclosed method. The memory 150 also includes data memory 170 that includes any configuration data, settings, user options and preferences that may be needed by the program memory 160, or any element of the device 100.

In an alternate embodiment, instead of the input device 120 and the display 130 being integrated into a touchscreen 125, separate physical components may be utilized for the input device 120 and the display 130. For example, a touchpad (or trackpad) may be used as the input device 120, and a separate or standalone display device that is distinct from the input device 120 may be used as the display 130. Examples of standalone display devices are: an LCD display screen, an LED display screen, a projected display (such as a heads-up display device), and so on.

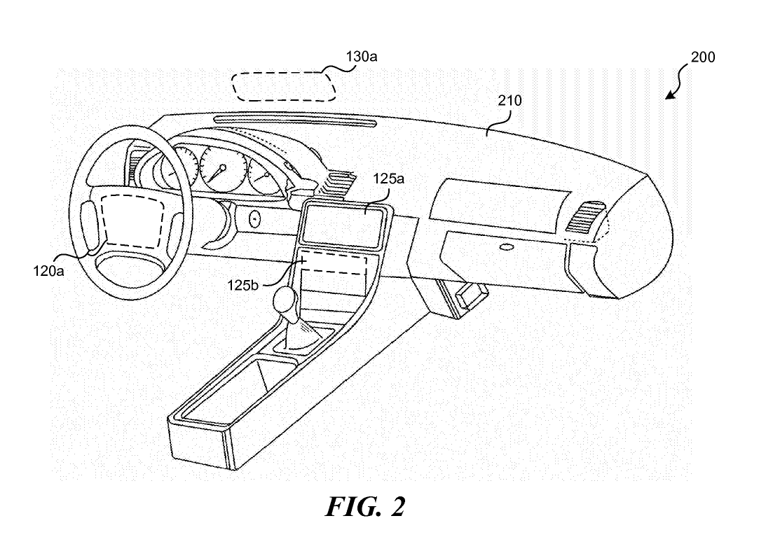

FIG. 2 is a perspective diagram of the touch-based system 100 of FIG. 1 in an exemplary automotive environment 200 for use by a driver. A touchscreen 125a may be mounted in a vehicle dashboard 210 or a touchscreen 125b may be mounted in an automobile center console. Alternate embodiments may utilize different input devices 120 and display devices 130. For example, a heads-up display 130a may be projected onto the automotive windshield, in combination with a touchpad 120a being integrated into the steering wheel. Despite the display being projected onto the windshield, the features of the disclosed low-attention gestural user interface are still useful because the driver may not be able to focus simultaneously on the elements of the heads-up display 130a and also on the moving environment around the automobile. Where the input device 120 is incorporated into the steering wheel, the system may optionally sense and compensate for the rotation of the steering wheel when interpreting the direction of the swipe to the input device, such as for example, to ensure that a leftward swipe gesture from the driver's perspective reads leftward (instead of some other direction) when the steering wheel is arbitrarily rotated.

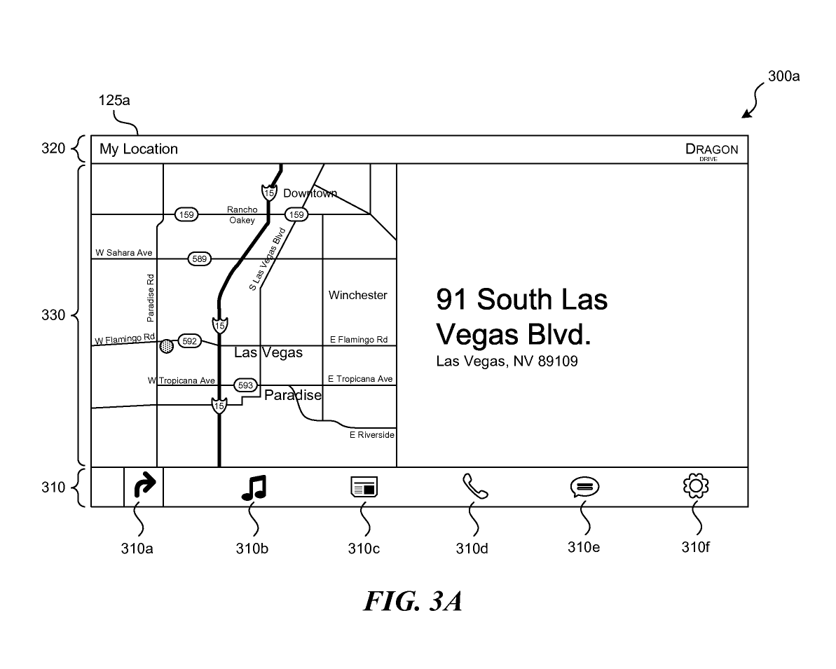

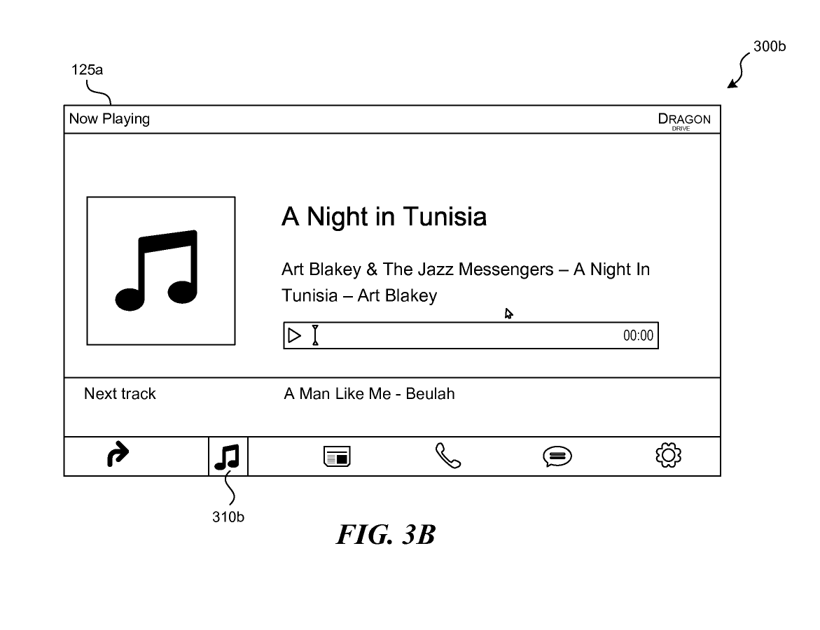

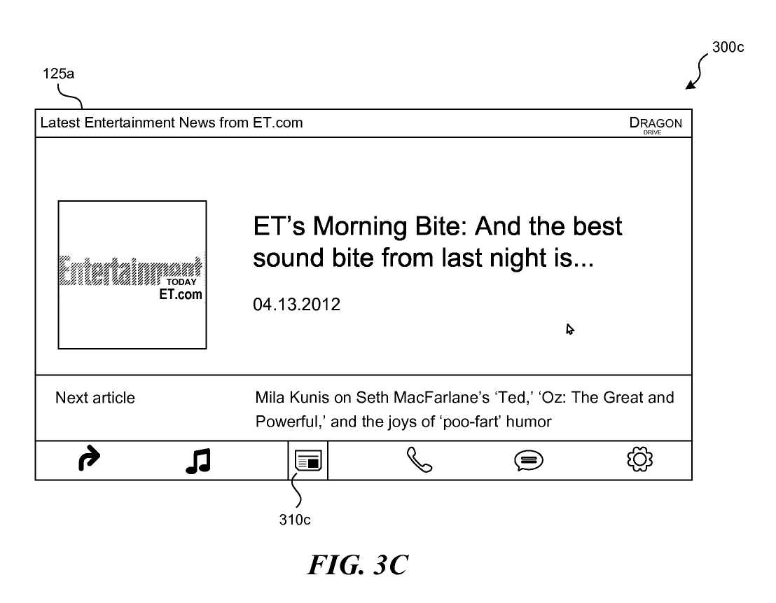

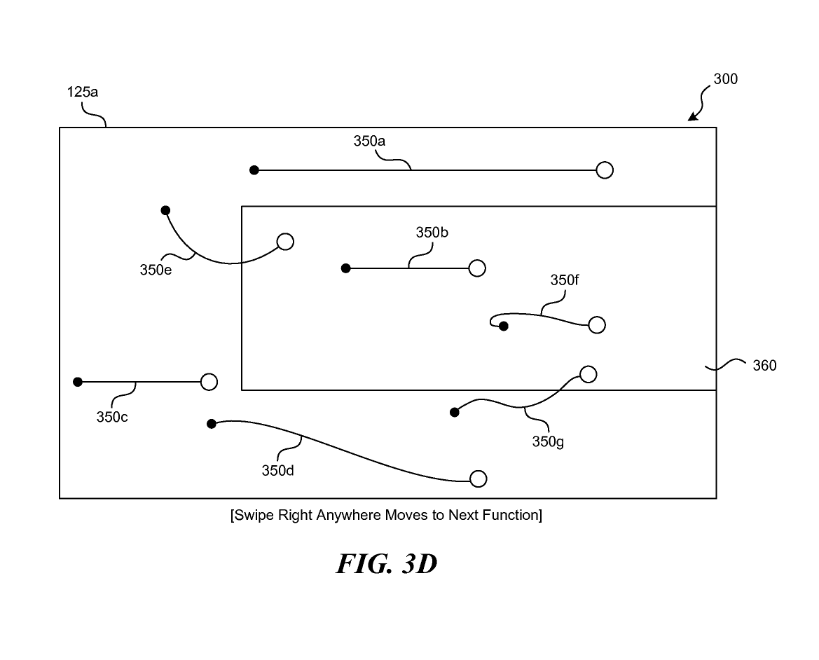

FIGS. 3A-C are screenshots of representative user interfaces 300 that illustrate exemplary navigable functions displayed on, for example, a vehicle touchscreen 125a, including: a vehicle navigation user interface 300a; a music player user interface 300b; and a news reader user interface 300c. For the sake of brevity, the user interfaces for some functions are not illustrated.

A horizontal menu bar 310 appears at the bottom of the screen corresponding to the different navigable functions, with the currently-active function being highlighted (e.g., by a different color or graphics treatment of the icon, by bolding the icon, etc.). In a left to right order, the menu contains the following icons: a navigation icon 310a, a music icon 310b, a news icon 310c, a telephone icon 310d, a messaging icon 310e (such as for instant messaging, e-mail, or text messaging), and an options icon 310f.

The icon associated with the currently-active function is highlighted. For example, when the navigation user interface 300a is displayed, the navigation icon 310a is highlighted. When the music user interface 300b is displayed, the music icon 310b is highlighted. And when the news user interface 300c is displayed, the news icon 310c is highlighted. Other active interfaces will result in the other icons being highlighted. To navigate between the various user interfaces 300, a user makes a rightward—(left-to-right) or leftward—(right-to-left) swiping motion (or “swipe gesture”) on the touch sensor. A rightward-swipe gesture causes the system to display the user interface associated with the adjacent feature on the menu bar 310 to the right of the current feature to be displayed, and a leftward-swipe gesture causes the system to display the user interface associated with the adjacent feature on the menu bar to the left of the current feature to be displayed. For example, a rightward-swipe gesture from music user interface 310b will take the user to the news user interface 310c, and a leftward-swipe gesture from the music user interface 310b will take the user to the navigation user interface 310a.

FIG. 3D is a schematic of exemplary rightward-swipe gestures 350a-g that a user can perform on the touch sensor in order to navigate from a user interface for a currently-displayed function to a user interface for an adjacent function. The start of a swipe gesture is indicated by a black dot in FIG. 3D, the end of the swipe gesture indicated by a circle, and the path of the swipe gesture is indicated by a connecting line between the two. Each of the swipe gestures 350a-g are interpreted by the system 100 as representing the same command. For example, any rightward-swipe gesture 350 can change the function from the navigation user interface 300a to the music user interface 300b, and also changes the corresponding highlighted icon from the navigation icon 310a to the music icon 310b. As another example, any rightward-swipe gesture 350 can change the currently active function from the music player user interface 300b to the news user interface 300c (and also the corresponding highlighted icon from the music icon 310b to the news icon 310c).

To improve operation in low-attention environments, each of the rightward-swipe gestures 350a-g are interpreted by the system 100 as the same user command, regardless of the swipe gesture's starting position on the screen and the extent of the swipe gesture (which may be defined as the distance between the point of origin and destination of the gesture, or the length of the path traversed between the point of origin and destination along the path of the swipe gesture). For example, the gestures 350a and 350d, despite having a greater extent than the shorter gestures 350b, 350c, 350e, 350f, and 350g are treated as the same user command as the shorter gestures. Also, a curved path of a right-swipe gesture 350f is treated the same as the linear path 350b. So, if a driver enters a user input while the vehicle is going over a bump, such as may have occurred for gesture 350g, the rightward-swipe gesture is still properly recognized by the system. Although the system may not differentiate two swipe gestures based on their extent or length, the system may use a minimum threshold length to determine whether to treat a particular input gesture as a tap gesture or a swiping gesture.

Regardless of where the swipe gesture 350a-f begins or ends, it is interpreted by the system 100 as the same command. For example, 350b and 350f being in a region 360 are treated the same as 350a, 350c, and 350d, which are not in the region 360. Moreover, the swipe gesture 350e and 350g, which are partly in the region 360, are treated the same as all of the other right-swipe gestures 350a, 350b, 350c, 350d, and 350f. As such, the entire surface of the touchscreen 125 or the touchpad acts as one large, unified input target rather than a collection of various input targets with various predefined active areas. Moreover, the system may disregard the velocity profile of a swipe gesture 350 and interpret a swipe gesture 350 as the same command, regardless of the velocity or acceleration with which the user enters the gesture motion. While FIG. 3D reflects exemplary rightward-swipe gestures, it will be appreciated that the mirror-image of the figure would represent exemplary leftward-swipe gestures which the system 100 treats in an analogous fashion.

While the system 100 disregards starting position, ending position, length, velocity, or acceleration when mapping the swipe gestures 350a-f to a command, in some embodiments to interpret the gesture the system may use the number of fingers used by the user to perform the gesture. Touchpads and touchscreens are typically able to detect the presence of multiple simultaneous touch locations on the touch surface. The system may therefore interpret the presence of one or more touches as a swipe with one finger, two fingers, or three fingers. Depending on the number of detected fingers, the system may map the detected gesture to a different command.

While the rightward- or leftward-swipe gestures are described herein as allowing a user to navigate between different functions on a vehicular control panel, it will be appreciated that the swipe gestures may be mapped to other commands within a user interface in other environments. The disclosed user interface is particularly beneficial for automotive environments, however, because it allows for quick horizontal navigation through a menu structure.

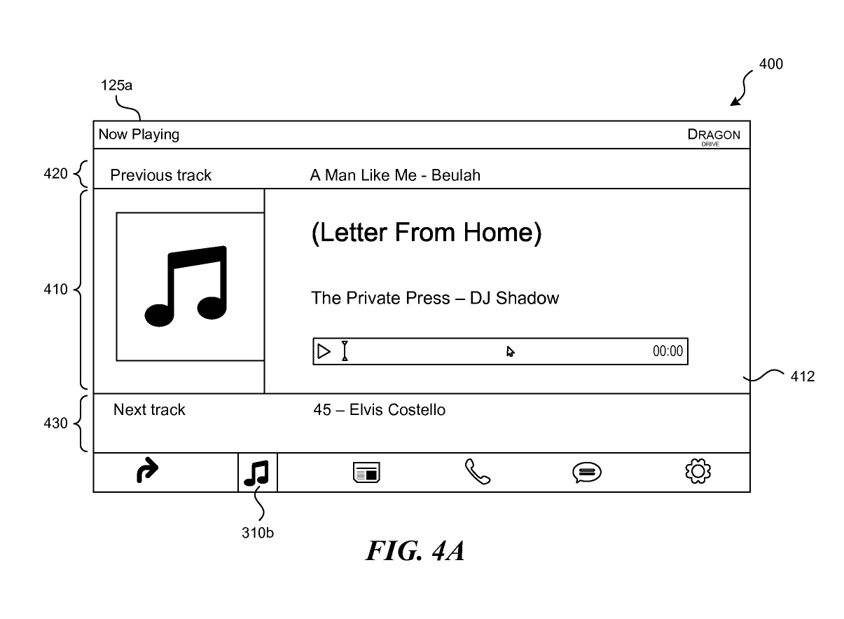

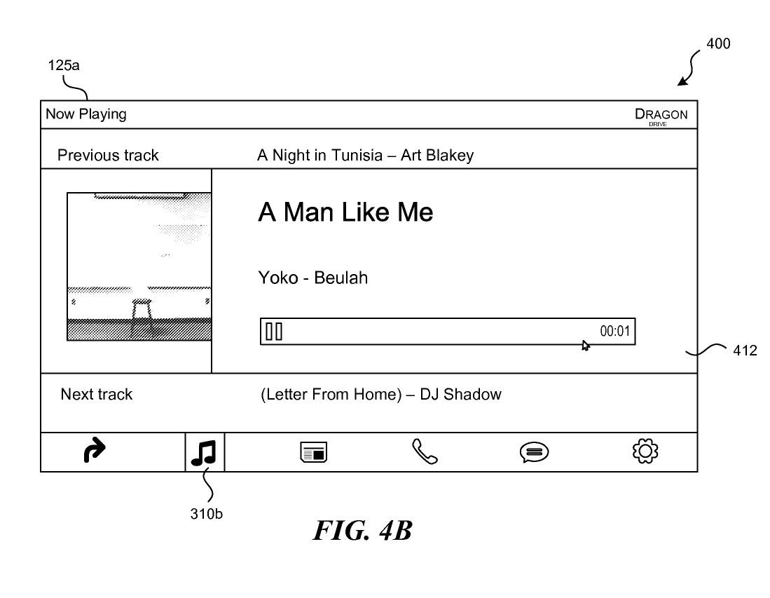

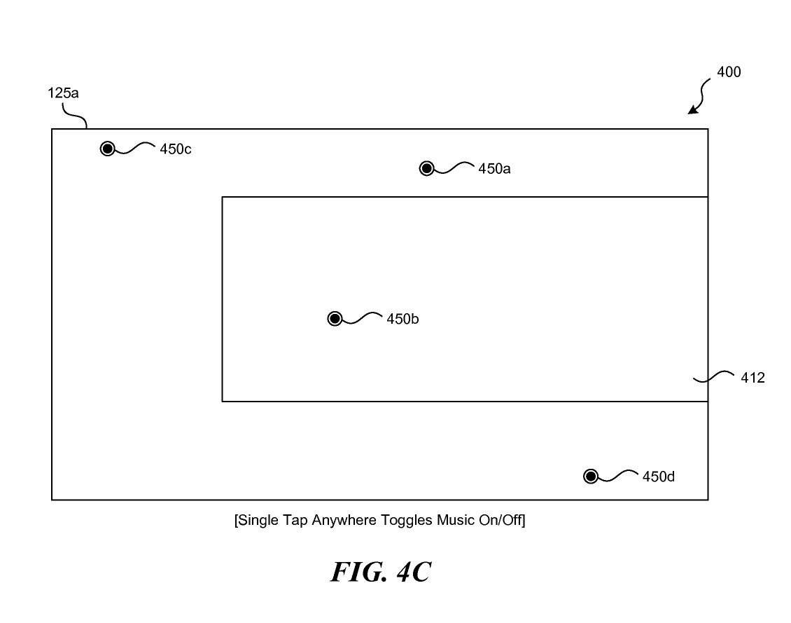

Once a user has selected a particular function as represented by an icon on the horizontal menu bar 310, the system 100 allows the user to navigate to and select various features within the selected function by using a combination of upward-swipe gestures, downward-swipe gestures, and taps. FIG. 4A is a screenshot of a representative user interface 400 that illustrates exemplary vertically-navigable list items that the automotive touchscreen 125a displays to the driver while using the music user interface. A currently selected music track 410, a previous track 420, and a next track 430 are illustrated in the user interface 400 of a music player. As shown, the currently-selected track 410 is not being played. A play symbol in the central area 412 indicates that the system will initiate playing the currently selected music track 410 in response to receiving a tap input anywhere on the user interface.

To navigate from the currently-selected track 410 to the previous track 420 or to the next track 430, the user may input a downward-swiping (i.e., top to bottom) or an upward-swiping (i.e., bottom to top) motion, respectively. As with the rightward-swipe gesture 350 and leftward-swipe gesture, the system interprets an upward-swipe or downward-swipe gesture the same without regard for the position of the swipe gesture with respect to a region on the screen, without regard for the extent of the swipe gesture (except to distinguish the motion as a swipe gesture from a tap gesture), and without regard to the velocity or acceleration profile of the swipe gesture (e.g., without regard to the terminal velocity).

FIG. 4B illustrates an exemplary automotive touchscreen user interface 125a of a music player after the currently selected track 410 of FIG. 4B is changed to the previous track 420, e.g., in response to the system receiving a downward-swipe gesture from a user. As indicated by the pause icon, the music player has initiated playback of the currently selected track, e.g., in response to receiving an earlier tap gesture from a user, as described further herein.

FIG. 4C illustrates exemplary single tap gestures 450a-d that a user may perform on the touchscreen in order to cause a music player to begin playing a currently selected music track, or if a track is already playing, to pause playback. Note that, like the swipe gestures recognized by the system, the location of each of the single tap gestures 450a-d does not matter and is not analyzed or used by the system to determine an appropriate responsive command. A tap in the upper-middle location of the screen 450a is treated the same as a tap in the upper-left location of the screen 450c as well as a tap in a lower-right location 450d of the screen 125a. Moreover, a tap in a specific region 412 of the screen 125a (e.g., tap 450b) is interpreted the same as a tap outside of that region (e.g., 450a, 450c, and 450d). Indeed, the location of any tap is interpreted as the same command, depending on the context, such as a screen in which the tap is received, a current mode, or the currently selected function or item.

In some embodiments, the system 100 may interpret the number or length of tap as being associated with a different command. A single tap may be recognized differently than a double tap; and a short tap may be recognized differently than a long tap (e.g., a tap gesture that exceeds a time threshold). In some embodiments, the system may use the number of fingers used by the user to perform the tap as being associated with a different command. The system may therefore interpret the presence of a one-finger tap differently from a two- or three-finger tap. For example, the system 100 may interpret a two-finger tap as a “back” or “undo” command.

The system 100 may provide auditory cues to reduce the need for a driver to take his eyes off the road. For example, a prerecorded or synthesized voice may announce the currently-selected function after the user changes the function. To illustrate, the system may play the phrase “music player” via the speaker 140 (or play a connotative sound, such as a short musical interlude) when the user changes the function to a music player. The voice may additionally or alternatively announce the currently-available feature that would be implemented by a tap after the user changes the function. To illustrate, the system may play the phrase “play track” via the speaker 140 (or play a connotative sound) when the user changes the function to a music player and an audio track is displayed to the user. As another example, when a user vertically swipes to navigate to a next item in a collection (e.g., to a selected audio track), part or all of that item's title may be read aloud by a prerecorded or synthesized voice. To illustrate, when the user swipes down or up to select a previous 420 or next 430 track, the speaker 140 may announce the selected track name, for example: “A Man Like Me, by Beulah”.

Since the system does not interpret the location or the extent of the swipe gestures received from a user, a driver can reliably change the function from the vehicle navigator 300a to the music player 300b, and then also reliably select a desired music track 420 without taking the driver's eyes off the road. And because the location of the tap gesture 450 within a touchscreen does not affect how the system interprets the tap gesture, the automobile driver can also play or pause the currently-selected track without taking his eyes off the road.

With the exemplary automotive touchscreen user interface 125a, generally speaking, the currently-selected function and/or list item is always in focus, and serves as the implicit target of tap inputs. That is, a tap input received by the system 100 will implement the selected function or list item that is currently displayed on the touchscreen.

The system may perform commands in response to double-tap or long tap inputs that are different to the commands assigned to single, short tap inputs. For example, in response to a long-tap (a single tap gesture that is held down for more than a predetermined time threshold, which may generally be in the range of 0.5-2.0 seconds) the system may perform a “back” or “undo” command that causes the system to reverse, cancel, or undo a previous command. As another example, the system may interpret a double-tap (two separate tap gestures that occur within a predetermined time threshold, which may generally be in the range of 0-2.0 seconds) as a user request to provide a voice command, or a voice-based search query on the currently selected item or function. An example of using a voice search command follows. Similarly to how the single-tap gesture 450 can be performed anywhere on the touchscreen 125a, the system may interpret a double-tap or long-tap gesture the same regardless of where it is performed on the touchscreen 125a.

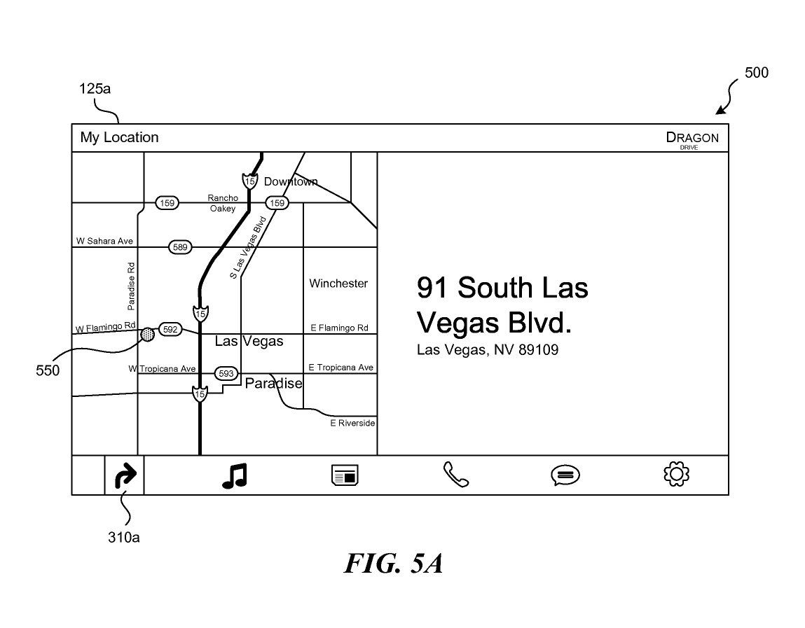

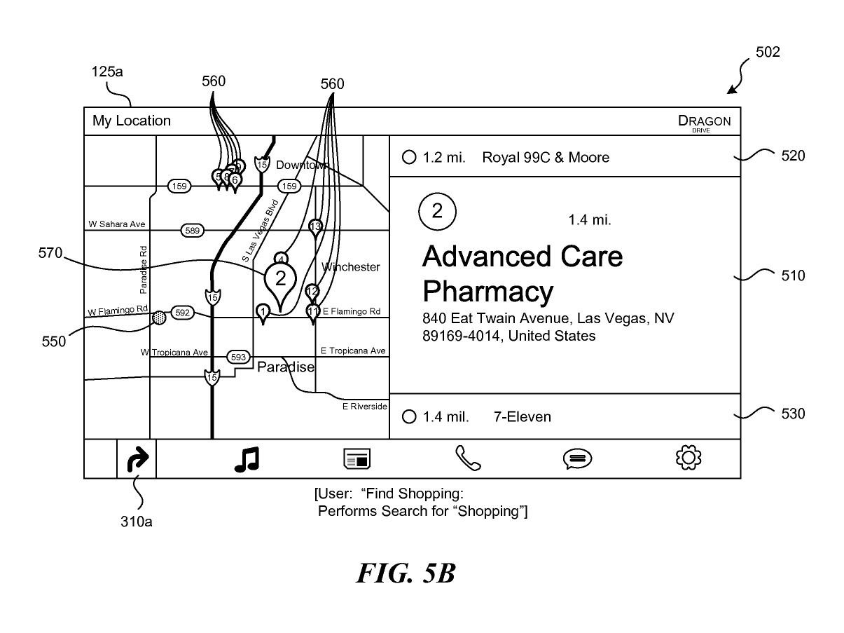

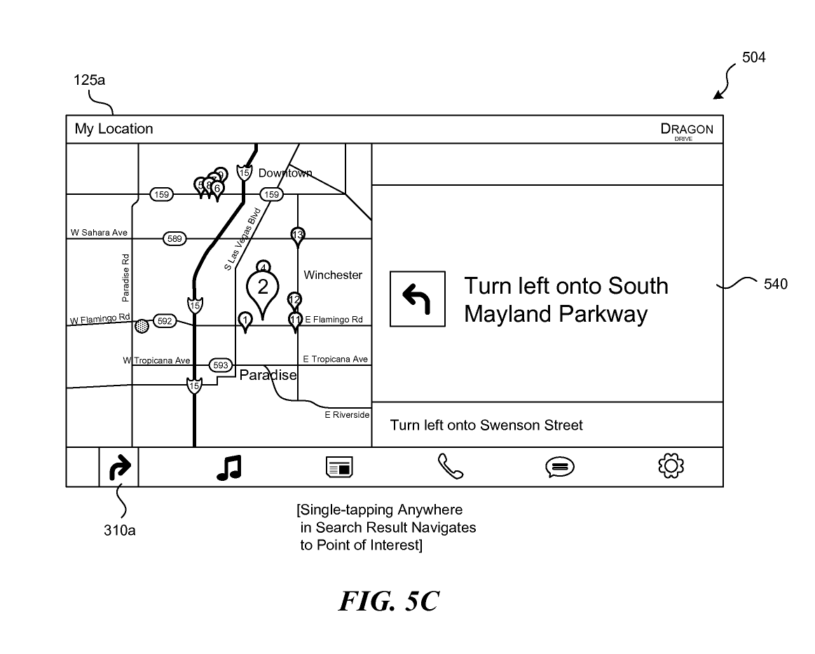

FIGS. 5A-C are screenshots of an exemplary user interface of a navigation application, such as might be used in an automobile to find and navigate to a nearby point of interest in a “shopping” category. In FIG. 5A, the touchscreen 125a displays a user interface 500 for a vehicle navigation application. The user interface 500 depicts a current address and map location 550 of a vehicle, e.g., as determined from a Global Positioning System (GPS) subsystem integrated with the system 100. The data memory 170 may contain the map data used to produce the interface 500.

In response to receiving a double-tap gesture from a user anywhere on the touch sensor, the system 100, via the speaker 140, may prompt the user to enter a voice command. The system monitors for audio input received from the microphone 141, including any spoken commands issued by a user, and converts the received user voice into an actionable command using speech-to-text conversion and matching the resulting translated text against a set of allowable commands.

For example, the system may receive a double-tap gesture followed by a spoken command to “find shopping.” In such an example, in response, the system may search for relevant results in the vicinity of the user and provide an updated interface 502, such as that shown in FIG. 5B, for the navigation application. The updated interface 502 provides search results using graphical icons 560, 570 displayed on a map and/or in a navigable list format. The driver can navigate through a list of search results by using upward-swiping and downward-swiping gestures anywhere on the touchscreen 125a to navigate from a currently-selected search result 510 (corresponding to a currently-selected search graphical icon 570 on a map that is graphically differentiated from the other graphical icons 560, e.g., by size or highlighting) to either a next search result 530 or a previous search result 520. The user may navigate through the various search results in a manner similar to that described earlier for navigating audio tracks in a music player, that is by using upwards- and downwards-swipe gestures. The system, via the speaker 140, may also provide auditory feedback of the search results to further reduce the need for the user to look at the touchscreen display 125a. For example, the system may read the displayed information for the currently-selected search result (e.g., “Advanced Care Pharmacy” or may indicate the feature available by the selection of the displayed result (e.g., “Navigate to Advanced Care Pharmacy”).

The system may receive a single-tap gesture anywhere on the interface 502 and interpret the single-tap gesture as indicating that the user wishes to receive more information for the currently selected search result 510, such as directions to the location or address associated with the currently-selected search result. In response to receiving a single-tap gesture, the system may provide an updated user interface 504 as shown in FIG. 5C. As shown, the updated interface 504 provides a sequence of directions 540 that provide navigation from the current address and map location 550 of the vehicle to the location of the selected search result, in this case, the “Advanced Care Pharmacy.”

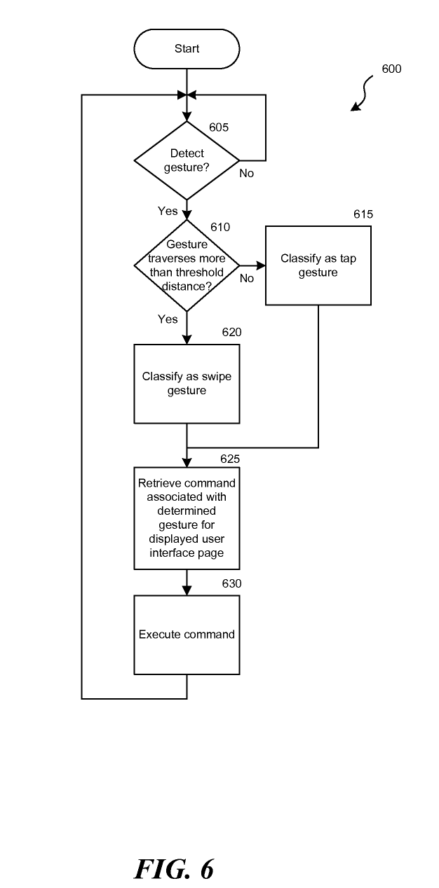

FIG. 6 illustrates a flow diagram of a method 600 performed by the system 100 of detecting a gesture and mapping the gesture to a command associated with the displayed user interface. The method 600 begins at decision block 605, where the system 100 determines whether a gesture has been detected. If no gesture has been detected, the method repeats starting at block 605. Otherwise, if a gesture is detected, the method 600 proceeds to block 610, where the system 100 determines whether the detected gesture traverses more than a threshold distance. The threshold distance is a predetermined distance used to differentiate whether a user input will be treated as a tap gesture or a swipe gesture. Use of a threshold distance ensures that slight movements in a tap gesture caused by, for example, automobile motion, are not interpreted as a swipe gesture. If the system determines that the gesture does not traverse more than a threshold distance, the process 600 proceeds to block 615, where the system classifies the detected gesture as a tap gesture. Otherwise, if the system determines that the gesture traverses more than a threshold distance, the process 600 proceeds to block 620, where the system classifies the detected gesture as a swipe gesture.

At block 625, the system retrieves a command associated with the determined gesture that is appropriate for a user interface page that is currently being displayed to the user. For example, the system may analyze the direction of a swipe gesture to determine that it is a downward swipe gesture and determine which user interface page is currently being displayed to the user and retrieve a command associated with a downward swipe gesture for that particular user interface page. At block 625, the system may determine, analyze, or otherwise use the direction of a swipe gesture, the number of fingers used to create the gesture, the nature of a tap gesture (e.g., single or double), and/or the duration of a tap gesture (e.g., short or long), but will typically not analyze the location of a gesture (e.g., its origin or termination point), velocity or acceleration profile, or the extent or length of a detected swipe gesture in order to retrieve the command. The process 600 then proceeds to block 630, where the system executes the command retrieved at block 625. The process 600 then repeats starting at block 605.

The system 100 has been described as detecting, interpreting and responding to four kinds of swipe gestures: rightward swiping, leftward swiping, upward swiping, and downward swiping. However, the system may recognize and respond to swipe gestures in fewer directions (for example, only leftward-swiping and rightward-swiping but not upward-swiping and downward-swiping). The system may also recognize and respond to swipe gestures in more directions, such as diagonal swipe gestures.

As described previously, swipes in different directions are mapped to different commands. For example a vertical swipe in one direction might highlight the previous item in a collection of items, whereas a vertical swipe in the opposite direction might highlight the next item in a collection of items. The command associated with a particular swipe gesture will depend on the content of the screen on which the swipe gesture was received, as well as any particular mode that the user may have previously entered, such as by tapping the touch sensor. Although each particular swipe direction discussed above (e.g., upwards, downwards, leftwards, rightwards) has been described above as being associated with a particular command, it will be appreciated that each of these particular commands might instead be associated with a different particular direction than the one described above.

In some examples, the system may place greater emphasis or importance on the initial portion of a swipe gesture than the later part of the motion (or vice-versa). For example, if the system places greater emphasis on the initial portion of a swipe gesture, then the system may interpret gesture 350e as a downward-swipe, instead of a rightward-swipe since the gesture plunges downward initially before traversing right. In any case, for an input gesture to be interpreted as a swipe, there must be a sufficient distance between the beginning of the motion and the end of the motion (e.g., a distance greater than a predetermined threshold), or else the system will interpret the user input as a tap.

In some embodiments, the system 100 may recognize and interpret additional single- and multi-finger gestures besides swipes and taps and associate these additional gestures with additional commands. For example, the system may recognize a gesture of “drawing a circle” anywhere on the screen and may interpret a circular gesture differently than a tap. For circular gestures, the system may recognize and interpret the direction of the drawn circle. The action taken by the system in response to the circular gesture may therefore be different depending on the direction of rotation. For example, the system may interpret a clockwise circle differently than a counterclockwise circle. In order for the system to distinguish a circle from a tap, the system may apply a minimum threshold radius or diameter and determine whether a radius or diameter for a received gesture exceeds the threshold in order to determine whether the gesture was a tap or circle. As another example, the system may detect and interpret a double-finger rotation gesture as a unique gesture that is associated with a specific command, e.g., increasing or decreasing the music volume by a fixed increment, such as by 3 decibels. As yet another example, the system may detect and interpret a double-finger pinching or expanding gesture as increasing the magnification level of a map view by a predefined percentage. As another example, the system may provide a text input mode where the user provides handwriting input, such as single character text input, anywhere on the surface of the touch sensor. In this example, the system may detect and interpret the shape of the handwriting gestures traced on the surface matters, but may disregard the size and overall location of the handwriting gesture.

In some cases, the components may be arranged differently than are indicated above. Single components disclosed herein may be implemented as multiple components, or some functions indicated to be performed by a certain component of the system may be performed by another component of the system. In some aspects. software components may be implemented on hardware components. Furthermore, different components may be combined. In various embodiments, components on the same machine may communicate between different threads, or on the same thread, via inter-process communication or intra-process communication, including in some cases such as by marshalling the communications across one process to another (including from one machine to another), and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A method of interpreting touch-based gestures on a touch-sensitive input device to execute a command, the method comprising:
displaying a page of a graphical interface to a user on a display;
detecting a user gesture on a touch-sensitive input device, the user gesture comprising a start point and an end point and reflecting a desired action of the user associated with the displayed page of the graphical interface;
if the distance between the start point and the end point exceeds a threshold distance, determining a direction of the user gesture based on the start point and end point of the gesture;
identifying a command based on the displayed page of the graphical interface and the direction of the user gesture, the identification made without regard to the start point of the user gesture, the end point of the user gesture, a distance between the start point and end point of the user gesture, a velocity of motion between the start point and end point of the user gesture, or an acceleration of motion between the start point and end point of the user gesture; and
executing the identified command associated with the displayed page in order to perform the desired action of the user.

2. The method of claim 1, wherein the touch-sensitive input device and display are integrated in a touchscreen.

3. The method of claim 1, wherein the direction is upward, downward, leftward, or rightward.

4. The method of claim 1, further comprising providing the user an auditory announcement of available actions when displaying the page of the graphical interface.

5. The method of claim 1, further comprising detecting a number of fingers used to make the user gesture by the user.

6. The method of claim 5, wherein mapping the detected user gesture to a command is further based on the detected number of fingers used in the gesture.

7. The method of claim 5, wherein a two-finger gesture is treated as an “undo” or “back” command.

8. The method of claim 1, wherein the display and touch-sensitive input device are incorporated in an automobile.

9. The method of claim 8, wherein the graphical interface is a music interface, navigation interface, or a communication interface.

10. The method of claim 1 wherein the identified command is a command to perform a voice initiated command, and wherein executing the identified command comprises receiving a voice command from the user.

11. A computer-readable storage medium storing instructions that, when executed by a computing device, cause the computing device to perform operations for interpreting touch-based gestures on a touch-sensitive input device into a command, the operations comprising:
displaying a page of a graphical interface to a user on a display;
detecting a user gesture on a touch-sensitive input device, the user gesture comprising a start point and an end point and reflecting a desired action of the user associated with the displayed page of the graphical interface;
if the distance between the start point and the end point exceeds a threshold distance, determining a direction of the user gesture based on the start point and end point of the gesture;
identifying a command based on the displayed page of the graphical interface and the direction of the user gesture, the identification made without regard to the start point of the user gesture, the end point of the user gesture, a distance between the start point and end point of the user gesture, a velocity of motion between the start point and end point of the user gesture, or an acceleration of motion between the start point and end point of the user gesture; and
executing the identified command associated with the displayed page in order to perform the desired action of the user.

12. The computer-readable storage medium of claim 11, wherein the touch-sensitive input device and display are integrated in a touchscreen.

13. The computer-readable storage medium of claim 11, the operations further comprising providing the user an auditory announcement of available actions when displaying the page of the graphical interface.

14. The computer-readable storage medium of claim 11, the operations further comprising detecting a number of fingers used to make the user gesture by the user.

15. The computer-readable storage medium of claim 14, wherein mapping the detected user gesture to a command is further based on the detected number of fingers used in the gesture.

16. The computer-readable storage medium of claim 11, wherein the display and touch-sensitive input device are incorporated in an automobile, and wherein the graphical interface is a music interface, navigation interface, or a communication interface.

17. A method of interpreting touch-based gestures into commands on a touch-sensitive input device in a vehicle, the method comprising:
displaying on a display a current graphical interface comprising one of a navigation user interface, a music player user interface, or a communication interface;
detecting a user gesture on a touch-sensitive input device, the user gesture comprising a start point and an end point;
if the distance between the start point and the end point exceeds a threshold distance, determining a direction of the user gesture based on the start point and end point of the gesture;
identifying a command based on the current interface and the direction of the user gesture, the command reflecting a desired action of the user to switch from the current graphical interface to a different interface, wherein the identification is made without regard to the start point of the user gesture, the end point of the user gesture, a distance between the start point and end point of the user gesture, a velocity of motion between the start point and end point of the user gesture, or an acceleration of motion between the start point and end point of the user gesture; and
executing the identified command to switch to the different interface in accordance with the desired action of the user.

18. The method of claim 17, wherein the display is mounted in the vehicle's dashboard, center console, or is a heads-up display projected onto a windshield.

19. The method of claim 17, wherein the touch-sensitive input device is mounted in the vehicle's steering wheel, and wherein the identifying a command comprises sensing and compensating for the rotation of the steering wheel.

20. The method of claim 17, wherein the touch-sensitive input device and display are integrated in a touchscreen.
